(19) United States
(12) Patent Application Publication
(10) Pub. No.: US 2018/0171782 A1
(43) Pub. Date: Jun. 21, 2018

(54) DETECTING A MULTI-MODAL TRACER IN A HYDROCARBON RESERVOIR

(71) Applicant: Saudi Arabian Oil Company, Dhahran (SA)

(72) Inventors: Jason R. Cox, Ashland, MA (US); Martin E. Poitzsch, Northumberland, NH (US); Shannon L. Eichmann, Somerville, MA (US); Wei Wang, Quincy, MA (US); Hooisweng Ow, Woburn, MA (US); Sehoon Chang, Cambridge, MA (US); Rena Shi, Cambridge, MA (US); David Robert Jung, Cambridge, MA (US); Ayrat Gizzatov, Cambridge, MA (US); Mohammad Hamidul Haque, Somerville, MA (US); Anthony Andrew Kmetz, II, Cambridge, MA (US); Hsieh Chen, Cambridge, MA (US)

(73) Assignee: Saudi Arabian Oil Company, Dhahran (SA)

(21) Appl. No.: 15/822,546

(22) Filed: Nov. 27, 2017

Related U.S. Application Data
(60) Provisional application No. 62/434,804, filed on Dec. 15, 2016.

(51) Int. Cl. E21B 47/10

(52) U.S. Cl. CPC E21B 47/1015; G01N 2021/6439

(57) ABSTRACT

The present disclosure describes methods and systems for detecting a multi-modal tracer in a hydrocarbon reservoir. One method includes injecting a multi-modal tracer at a first location in a reservoir, wherein the multi-modal tracer mixes with subsurface fluid in the reservoir; collecting fluid samples at a second location in the reservoir; and analyzing the fluid samples to detect a presence of the multi-modal tracer in the fluid samples.

### CROSS REFERENCE TO RELATED APPLICATIONS

This application claims the benefit of priority of U.S. Provisional Application Ser. No. 62/434,804, filed on Dec. 15, 2016, which is incorporated by reference herein in its entirety.

### TECHNICAL FIELD

This disclosure relates to detecting tracers in a hydrocarbon reservoir.

### BACKGROUND

In a hydrocarbon reservoir, subsurface fluid flow patterns can be analyzed to develop a geological model for the hydrocarbon reservoir. The model can be used to generate one or more parameters that are useful in reservoir resource management, including, for example, well to well connectivity, fluid allocation, fracture locations, swept volumes and residual oil saturations.

### SUMMARY

The present disclosure describes methods and systems for detecting tracers in a hydrocarbon reservoir. One method includes injecting a multi-modal tracer at a first location in a reservoir, wherein the multi-modal tracer mixes with subsurface fluid in the reservoir; collecting fluid samples at a second location in the reservoir; and analyzing the fluid samples to detect a presence of the multi-modal tracer in the fluid samples. Other implementations of this aspect include corresponding systems and apparatuses.

The foregoing and other implementations can each, optionally, include one or more of the following features, alone or in combination:

A first aspect, combinable with the general implementation, the method further includes determining a subsurface fluid-flow pattern based on the detected presence of the multi-modal tracer.

A second aspect, combinable with any of the previous aspects, wherein the multi-modal tracer comprises a particle loaded with at least two taggants, and each of the at least two taggants is associated with a different detection technique.

A third aspect, combinable with any of the previous aspects, wherein the multi-modal tracer comprises a nanoparticle.

A fourth aspect, combinable with any of the previous aspects, wherein the multi-modal tracer is loaded with at least a fluorescence taggant and a mass spectrometry taggant.

A fifth aspect, combinable with any of the previous aspects, wherein analyzing the fluid samples comprises: determining a first barcode component, wherein the first barcode component represents a fluorescence signal generated using a fluorescence detection technique; determining a second barcode component, wherein the second barcode component represents a mass spectrometry signal generated using a mass spectrometry detection technique; generating a barcode based on the first and the second barcode components; and comparing the generated barcode with a plurality of barcodes to detect the presence of the multi-modal tracer, each of the plurality of barcodes representing a particular multi-modal tracer.

A sixth aspect, combinable with any of the previous aspects, wherein the fluorescence detection technique comprises an upconversion luminescence operation, and the fluorescence taggant comprises an upconverting taggant.

A seventh aspect, combinable with any of the previous aspects, wherein the fluorescence detection technique comprises a time-gated fluorescence spectroscopy technique, and the fluorescence taggant comprises sheathed lanthanide emitters or persistent phosphor materials.

An eighth aspect, combinable with any of the previous aspects, wherein the fluorescence detection technique is used to generate the first barcode component prior to the generation of the second barcode component using the mass spectrometry detection technique.

A ninth aspect, combinable with any of the previous aspects, wherein the mass spectrometry taggant is incorporated in a polymeric nanoparticle.

A tenth aspect, combinable with any of the previous aspects, wherein the mass spectrometry detection technique comprises a Gas Chromatography Mass Spectrometry operation.

An eleventh aspect, combinable with any of the previous aspects, wherein the multi-modal tracer is further loaded with a surface-enhanced Raman spectroscopy (SERS) taggant, and analyzing the fluid samples comprises: determining a third barcode component, wherein the third barcode component represents a SERS signal generated using a SERS detection technique; and wherein the barcode is generated based on the first, the second, and the third barcode components.

A twelfth aspect, combinable with any of the previous aspects, wherein the SERS taggant comprise a thermally stable dye molecule embedded within a nanoparticle.

A thirteenth aspect, combinable with any of the previous aspects, wherein the fluid samples are analyzed in real time at the second location.

A fourteenth aspect, combinable with any of the previous aspects, wherein the subsurface fluid comprises at least one of natural ga, petroleum, connate water, or seawater.

A multi-modal tracer for mixing with subsurface fluid in a reservoir includes: a fluorescence taggant associated with a first barcode component; a mass spectrometry taggant associated with a second barcode component; and wherein the first barcode component and the second barcode component form a barcode that identifies the multi-modal tracer.

The foregoing and other implementations can each, optionally, include one or more of the following features, alone or in combination:

A first aspect, combinable with the general implementation, wherein the fluorescence taggant comprises an upconverting taggant.

A second aspect, combinable with any of the previous aspects, wherein the fluorescence taggant comprises sheathed lanthanide emitters or persistent phosphor materials.

A third aspect, combinable with any of the previous aspects, wherein the mass spectrometry taggant is incorporated in a polymeric nanoparticle.

A fourth aspect, combinable with any of the previous aspects, wherein the multi-modal tracer further comprises a surface-enhanced Raman spectroscopy (SERS) taggant associated with a third barcode component; and wherein the barcode is formed by the first, the second, and the third barcode components.

The details of one or more implementations of the subject matter of this disclosure are set forth in the accompanying drawings and the subsequent description. Other features, aspects, and advantages of the subject matter will become apparent from the description, the drawings, and the claims.

### DESCRIPTION OF DRAWINGS

The patent or application file contains at least one drawing executed in color. Copies of this patent or patent application publication with color drawing(s) will be provided by the Patent and Trademark Office upon request and payment of the necessary fee.

FIG. 1 is a schematic diagram that illustrates an example multi-modal tracer detection system according to an implementation.

FIG. 2 is a schematic diagram that illustrates example multi-modal tracers according to an implementation.

FIGS. 3A and 3B are schematic diagrams that illustrates an example scenario of detecting multi-modal tracers according to an implementation.

FIG. 4 illustrates an example method for detecting a multi-modal tracer according to an implementation.

FIG. 5 is a schematic diagram that illustrates a fluorescence spectrum of a hydrocarbon product according to an implementation.

FIG. 6 illustrates an effect of upconversion according to an implementation.

FIG. 7 is an image that illustrates an example effect of using persistent phosphor materials according to an implementation.

FIG. 8 is a scheme diagram that illustrates the chemical structure of a sheathed lanthanide emitter according to an implementation.

FIG. 9 is a scheme diagram that illustrates example ligands according to respective implementations.

FIG. 10 illustrates an example surface-enhanced Raman scattering (SERS)-active tracer according to an implementation.

FIGS. 11A and 11B illustrate SERS spectra associated with a nanotracer as a function of concentration according to an implementation.

FIG. 12 illustrates Raman spectra of the SERS-active tracer with a variety of dyes.

FIG. 13 is a scheme diagram illustrating example multi-modal molecular tracers, example multi-modal macromolecular tracers, and example multi-modal nanotracers according to respective implementations.

FIG. 14 is a scheme diagram illustrating an example mass spectrometry (MS) taggant incorporated within polymeric nanoparticles according to an implementation.

FIG. 15 is a scheme diagram illustrating an example MS analysis according to an implementation.

Like reference numbers and designations in the various drawings indicate like elements.

### DETAILED DESCRIPTION

This disclosure generally describes methods and systems for detecting tracers in a hydrocarbon reservoir. In some implementations, tracer studies can be used to collect data for the subsurface fluid flow analysis. In a tracer study, one or more tracers can be injected at an injection site of the reservoir. The tracer can mix with the fluid in the subsurface under the injection site. For example, the tracer can diffuse into the fluid or can mix with the fluid due to advection. After some time, fluid samples can be collected at a producing site for analysis. The propagation patterns of the tracers between the injecting site and the producing site can be used to determine the presence and location of flow barriers and fractures between the two sites in the reservoir. In some cases, multiple injection sites and multiple producing sites can be selected in a reservoir. Tracers can be injected in each of the multiple injection sites and fluid samples can be collected at each of the multiple producing sites to analyze the fluid pattern of the entire reservoir.

The effect of the tracer study can depend on the sampling frequency of the collection and the analysis of the fluid samples at the second location. In some cases, time-consuming processes, including for example, collection, purification, and concentration, may be performed prior to laboratory tracer analysis. In these or other cases, the fluid samples can be collected manually and brought back to a lab to perform these time-consuming processes. The sampling is therefore infrequent, for example, once a week. Due to the long timescales between sampling, the duration of tracer breakthrough may not be detected accurately. This can be a source of uncertainty during quantitative analysis, and therefore leading to inaccurate calculations of swept volume, fluid allocation, reservoir heterogeneity, and other reservoir management parameters.

In some implementations, a multi-modal tracer that is loaded with multiple taggants can be injected into the subsurface of a reservoir. Each of the multiple taggants can be associated with a different detection technique. Examples of the detection techniques include fluorescence (FL) spectroscopy, mass spectrometry (MS), surface-enhanced Raman scattering (SERS), or any other tracer detection techniques. Fluid samples can be extracted and the multi-modal tracer can be detected in real-time using a multi-modal detection device located at the producing site.

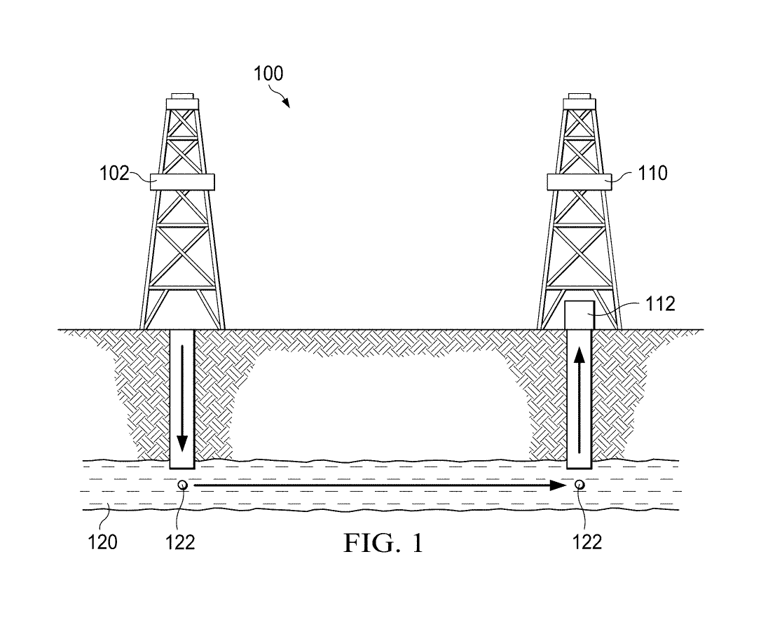

FIG. 1 is a schematic diagram that illustrates an example multi-modal tracer detection system 100 according to an implementation. The example multi-modal tracer detection system 100 includes a first wellbore drilling system 102 located at an injection site. The first wellbore drilling system 102 can be implemented to inject one or more multi-modal tracers 122 that can mix with subsurface fluid 120. The example multi-modal tracer detection system 100 also includes a second wellbore drilling system 110 located at a producing site. The second wellbore drilling system 110 can be implemented to extract subsurface fluid 120 at the producing site. The example multi-modal tracer detection system 100 also includes a multi-modal detection device 112 located at the producing site.

A wellbore drilling system, for example, the first wellbore drilling system 102 and the second wellbore drilling system 110, can be implemented to inject fluids into a subsurface of a reservoir, extract fluids from the subsurface of the reservoir, or a combination thereof. For example, the first wellbore drilling system 102 can inject fluid into the subsurface using a wellbore at an injection site. The second wellbore drilling system 110 can extract subsurface fluid using a wellbore at a producing site.

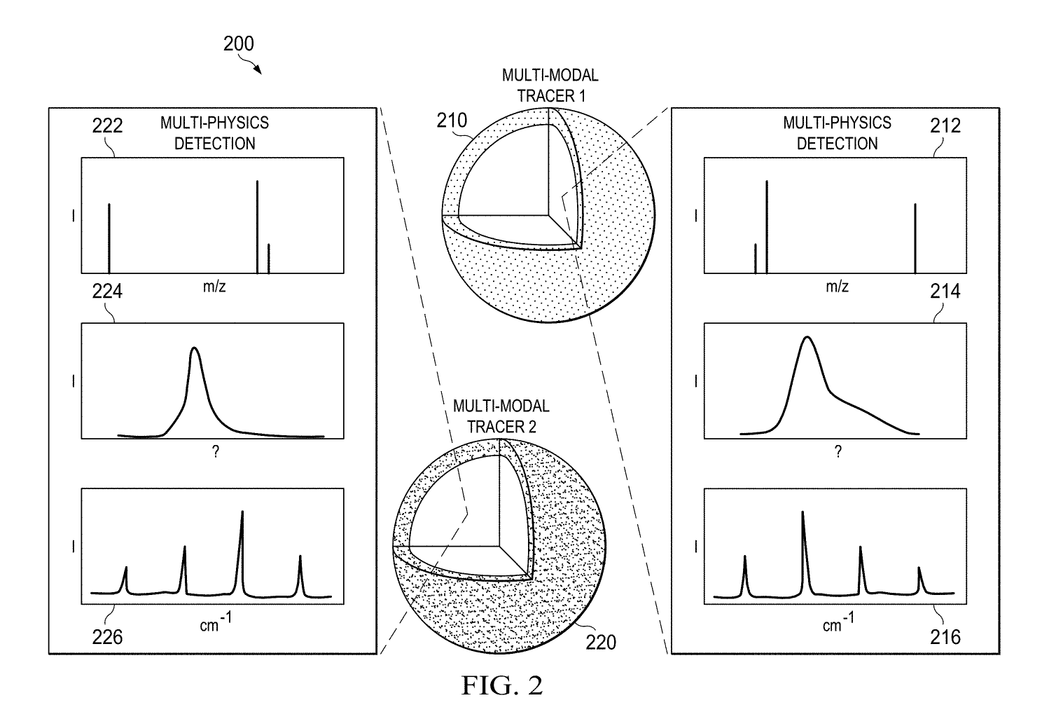

The multi-modal tracer 122 is a tracer that is loaded with more than one taggants. Each of the more than one taggants is associated with a specific detection methodology. FIG. 2 is a schematic diagram 200 that illustrates example multi-modal tracers according to an implementation. The schematic diagram 200 includes a first multi-modal tracer 210 and a second multi-modal tracer 220.

In the illustrated example, each of the multi-modal tracers 210 and 220 is loaded with three taggants: a FL taggant, a MS taggant, and a SERS taggant. Each taggant is associated with a different modality and can be detected using the respective detection methodology for that modality. A specific detection signal can be generated when a corresponding detection methodology is used to detect a multi-modal tracer. For example, when a FL detection is performed on the multi-modal tracer 210, a FL signal 212 can be generated. When a MS detection or a SERS detection is performed on the multi-modal tracer 210, a MS signal 214 or a SERS signal 216 can be generated. Each of the FL signal 212, the MS signal 214, and the SERS signal 216 represent a different component of a barcode for the multi-modal tracer 210. Similarly, each of a FL signal 222, a MS signal 224, and a SERS signal 226 represent a different component of a barcode for the multi-modal tracer 220.

As illustrated, the taggant associated with at least one modality of the multi-modal tracer 210 is different than the corresponding taggant associated with the same modality of the multi-modal tracer 220. Therefore, at least one bar code component of the multi-modal tracer 210 and the multi-modal tracer 220 are different. The mutli-modal tracers 210 and 220 can be differentiated based on the components of their barcodes. Using a linear combination of different taggants associated with each of the modalities, a library of barcodes can be generated. For example, if five different taggants are selected each for the FL, MS, and SERS modality, then 125 barcodes can be generated. Consequently, up to 125 different types of multi-modal particles can be used as tracers. Additional types of multi-modal particles can be available as the number of individual taggants increases. Using a multi-modal particle can significantly increase the number of unique tracers deployed in a tracer study of a reservoir.

In some implementations, the multi-modal particles can be implemented using nanoparticles. Alternatively, or in combination, the multi-modal particles can also be implemented using polymeric materials or inorganic compounds. For example, polymers containing monomeric units with functionalities that can be interrogated via different spectroscopic techniques can be incorporated within the same polymer chain. Inorganic complexes of rare earth (metallic ion) compounds coupled to various ligands can also be used.

In some cases, different multi-modal tracers from different injection site can arrive at the same producing site. If the fluid samples are collected infrequently, different tracers from different injection sites may arrive at the same producing sites within the same sample collecting period. Therefore, these tracers may be mixed together in the fluid samples, and may generate signals that are overlapped with one another and therefore may not be differentiated using the corresponding detection technology.

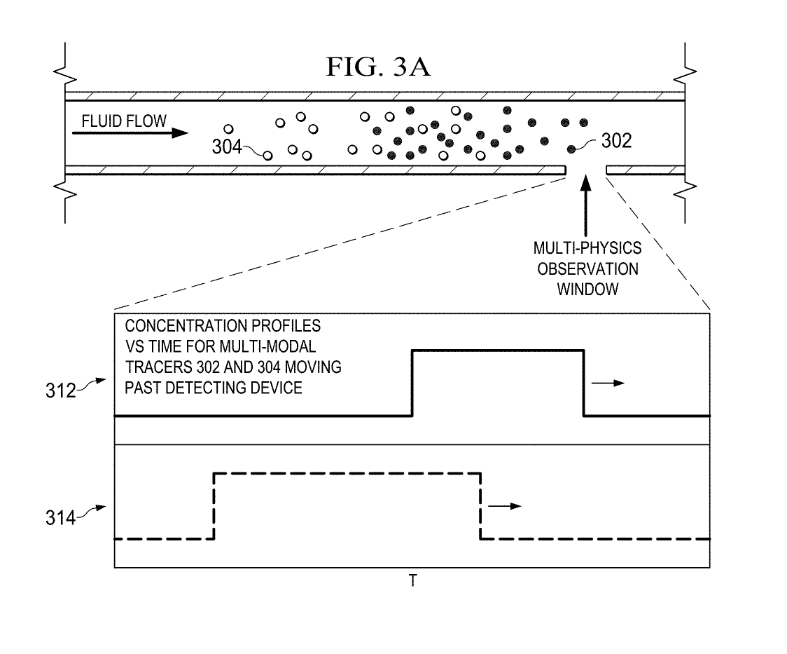

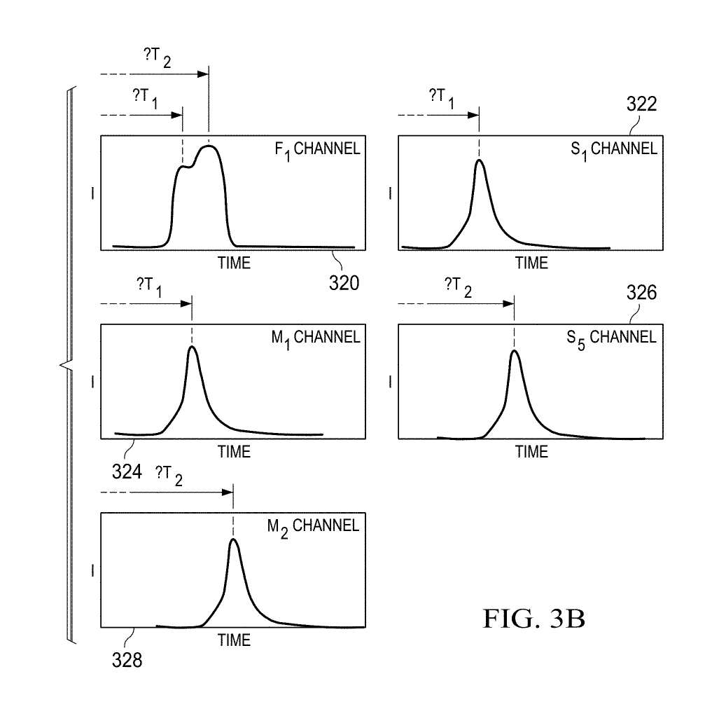

In some implementations, tracers can be detected at the producing site in real-time. Therefore, fluid samples can be collected frequently, and the tracers can be detected using the multi-modal detection device 112 in real-time. FIGS. 3A and 3B are a schematic diagram that illustrates an example scenario of detecting multi-modal tracers according to an implementation. As illustrated, two types of tracers, tracers 302 and 304, are injected into the subsurface fluid at different injection sites. Because of the differences in their traveling distances and fluid barriers in their traveling path, the tracers 302 and 304 can arrive at the producing site at different time. Charts 312 and 314 show the concentration profiles of the tracers 302 and 304 with respect to time. As illustrated, a high concentration level of the tracer 302 reaches the producing site before a high concentration level of the tracer 304. By performing frequent real-time detection at the producing site, the change of intensities of different tracers can be tracked to determine the arrival time of each tracer.

The difference in the time of arrival can be detected by the multi-modal detection device 112 that performs detections in real time.

In the illustrated example, the tracer 302 is loaded with the FL taggant F1, the MS taggant M1, and the SERS taggant S1. The tracer 304 is loaded with the FL taggant F1, the MS taggant M2, and the SERS taggant S5. The response curves 320, 322, 324, 326, and 328 show the simulated response curves of the detection signals generated by each of these taggants using corresponding detection technologies. As shown by the curves 322 and 326, the intensity of the SERS signal produced by S1 rises to peak level at ΔT₁ and before it falls, while the intensity of the intensity of the SERS signal produced by S5 rises to peak level at ΔT₂ and before it falls. Similarly, shown by the curves 324 and 328, the intensity of the MS signal produced by M1 rises to peak level at ΔT₁ and before it falls, while the intensity of the intensity of the MS signal produced by M2 rises to peak level at ΔT₂ and before it falls. The peak of the MS signal produced by M1 occurs at the same time as the peak of the SERS signal produced by S1, while peak of the MS signal produced by M2 occurs at the same time as the peak of the SERS signal produced by S5. Because the curves are generated at real-time and can represent the change of concentration levels for each type of tracers over time, the response curves generated by the tracers 302 and 304 can be differentiated.

Returning to FIG. 1, the example multi-modal tracer detection system 100 also includes the multi-modal detection device 112. The multi-modal tracer detection device is configured to detect the multi-modal tracer 122, using more than one detection technologies. Examples of the detection technologies include FL, MS, SERS, surface enhanced fluorescence spectroscopy (SEFS), ion mobility spectrometry (IMS), differential mobility spectrometry (DMS), magnetometry, electrochemistry, Atomic-Emission Spectroscopy (AES), Deoxyribonucleic acid (DNA) sequencing, or any other detection technologies. The multi-modal detection device 112 can be configured to detect the multi-modal tracers in real-time continuously without any human intervention. Therefore, the break-through activities, for example, when a high concentration level of the tracers first arrived at the producing site, can be captured accurately.

In addition to generating a large barcode library through incorporation of many taggants into a single tracer, using multi-modal tracers in a tracer study can also take advantage of different benefits provided by each detection technique. For example, FL detection is a fast detection technique that can be used for interrogation at low concentration levels. However, the photophysical properties of most organic and inorganic compounds may prevent the generation of a large library of tracer materials due to the diffuse nature of electronic transitions. MS detection, on the other hand, can provide atomic mass resolution of taggants and thereby enabling the identification of tens to hundreds of different taggants simultaneously. The downside to MS detection is that fluids may require some level of automated pretreatment prior to analysis. The multi-modal detection device 112 can combine these two detection strategies. FL detection can be performed in-flow to indicate the arrival of tracers. In response to the indication, the sampling of fluid can be initiated and the MS, the SERS, or a combination thereof, can be performed in response. This approach can provide both fast and high-resolution detection of tracers. This approach can also provide multiple confirmations that a tracer is present, which can be beneficial under the harsh downhole conditions of the reservoir.

In operation, at the injecting site, one or more multi-modal tracers 122 can be mixed with the drilling fluid and injected into the subsurface by the first wellbore drilling system 102. The one or more multi-modal tracers 122 can mix with the subsurface fluid 120. Examples of the subsurface fluid 120 can include hydrocarbon products such as natural gas or petroleum, connate water, seawater, or any combinations thereof. At the producing site, the second wellbore drilling system 110 can extract the subsurface fluid 120. Fluid samples from the extracted subsurface fluid 120 can be analyzed using the multi-modal detection device 112 at the producing site. The multi-modal detection device 112 can detect the presence of the one or more multi-modal tracers 122.

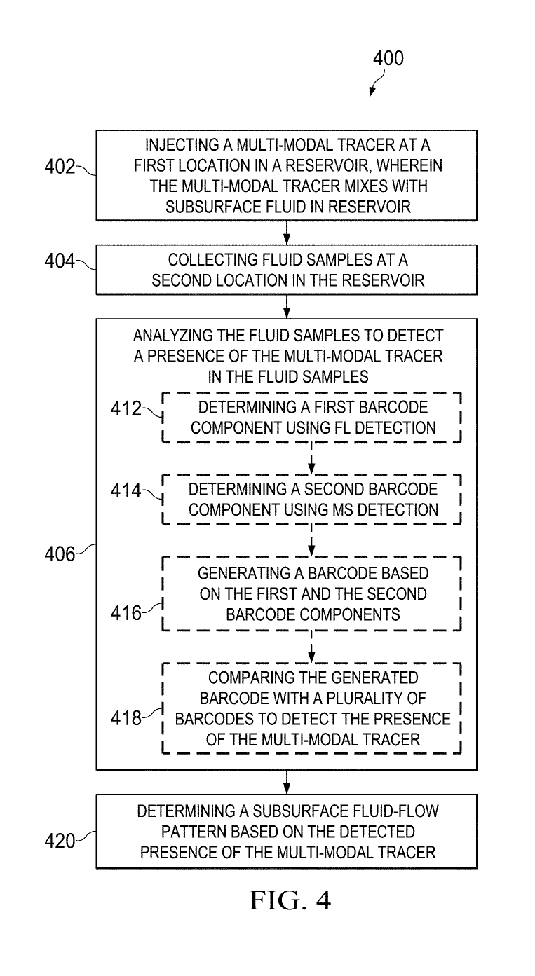

FIG. 4 illustrates an example method 400 for detecting a multi-modal tracer according to an implementation. For clarity of presentation, the description that follows generally describes method 400 in the context of FIGS. 1-2, 3A-3B, 5-15.

At 402, a multi-modal tracer is injected at a first location in a reservoir. The multi-modal tracer mixes with the subsurface fluid in the reservoir. The multi-modal tracer includes a particle loaded with more than one taggants, each of the more than one taggants is associated with a different detection technology. At 404, fluid samples are collected at a second location in the reservoir. At 406, the fluid samples are analyzed to detect a presence of the multi-modal tracer in the fluid samples. In one example, at 412, a FL detection is performed to generate a first barcode component representing an FL signal associated with the FL taggant loaded on the multi-modal tracer, at 414, a MS detection is performed to generate a second barcode component, representing an MS signal associated with the MS taggant loaded on the multi-modal tracer. In some cases, additional detections can be performed to generate additional barcode components. At 416, a barcode is generated based on the first and the second barcode components. In some cases, the barcode can be generated further based on additional barcode components. At 418, the generated barcode is compared with multiple barcodes to detect the presence of the multi-modal tracer, where each of the multiple of barcodes is representing a particular multi-modal tracer. At 420, a subsurface fluid-flow pattern can be determined based on the detected presence of the multi-modal tracer.

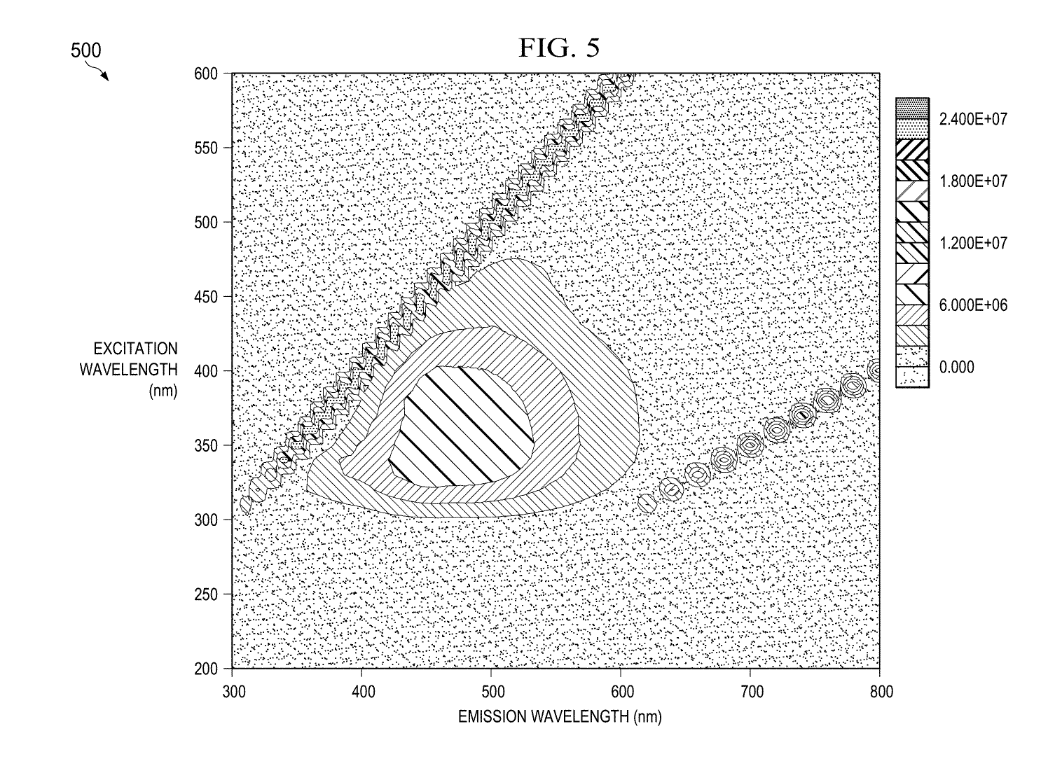

FIG. 5 is a schematic diagram 500 that illustrates a fluorescence spectrum of a hydrocarbon product according to an implementation. Fluorescence spectroscopy is an optical interrogation technique that probes transitions between electronic states in molecules and atoms. In one example, a material is illuminated with photons of a particular wavelength and energy, closely matching the energy gap between electronic states. The molecule or atom can absorb the photon and achieve an excited electronic state. This state can then decay through multiple pathways, one of which may be the subsequent emission of a lower energy photon—a process commonly referred to as fluorescence. This form of interrogation is attractive due to the ability to achieve low detection limits and the non-destructive nature of the analysis.

For reservoir tracing applications, traditional fluorescence spectroscopy may have one or more issues. One issue is the presence of fluorescent materials within the oil matrix itself, providing a strong background signal. The schematic diagram 500 illustrates a two-dimensional fluorescence spectrum of Arabian-light crude oil. The horizontal axis represents the emission wavelengths. The vertical axis represents the excitation wavelengths. The two diagonal lines are an artifact of the measurement technique. As illustrated, the crude oil fluorescence dominates the visible portion of the spectrum (350-600 nanometers), which may impact the detection of tracers mixed with the crude oil. To mitigate this issue, complex separations and purifications may be performed to remove the background signal before the detection process of the tracers. This approach may be costly and time-consuming.

In some cases, upconversion or time-gated fluorescence spectroscopy can be used to improve the FL detection process. In an upconversion photophysical process, a material may emit photons of a higher energy than those that were absorbed. This anti-Stokes process may occur by two mechanisms: two-photon excitation or through long-lived metastable excited states. In a two-photon excitation process, a material can be excited with coherent high-power density lasers to enable near simultaneous adsorption of two-photons. The resulting excited state relaxes through emission of a photon with an energy roughly two times that of the exciting photons. Most molecules are capable of excitation through this mechanism. However, the quantum yields may be low so powerful excitation sources may be used. In a long-lived metastable excitation process, rare earth ion doped nanocrystals, that can be excited with low power sources such as continuous wave (CW) lasers or halogen lamps, can be used. Mechanistically, the rare earth ions are capable of achieving long-lived metastable excited states that allow multiple photons to be absorbed prior to an emission event, thus giving rise to an anti-Stokes type emission.

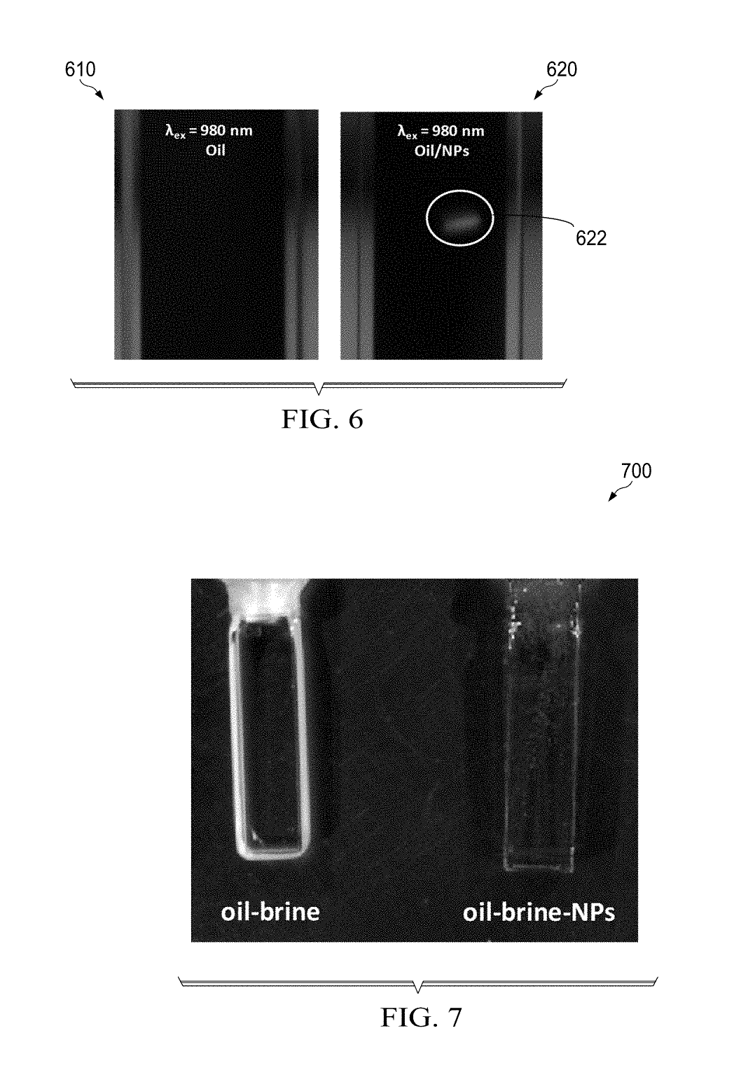

The upconversion luminescence can be used in the multi-modal detection process discussed previously. Upconverting taggants may be included as one element in a multi-component material that forms the multi-modal tracer. The tracers can undergo excitation at a wavelength that does not trigger fluorescence from the oil, thereby providing a clean observation of tracer luminescence in the presence of crude oil and reducing or avoiding additional separation procedures. FIG. 6 illustrates an effect of upconversion according to an implementation. FIG. 6 includes a first luminescence image 610 that is generated without upconversion and a second luminescence image 620 that is generated using upconversion. As illustrated, a luminescence region 622 is shown in the second luminescence image 620, indicating the presence of the tracer including an upconverting taggant.

Alternatively, or in combination, time-gated fluorescence spectroscopy can be used to separate the luminescence of the tracer from the background fluorescence of the crude oil. In time-gated fluorescence spectroscopy, materials capable of emitting photons, on a time-scale longer than that of crude oil, can be used. The majority of chromophores in crude oil emit photons on a time scale of nanoseconds after excitation. Materials including sheathed lanthanide emitters and persistent phosphors can emit on a timescale of microseconds to hours, allowing for sample excitation with a pulsed flash lamp. This approach, followed by gating of the detection window, enables singular and unconvoluted sample observation after the crude oil has stopped emitting. This technique can achieve low detection limits in otherwise confounding media.

Persistent phosphor materials include inorganic complexes whose luminescence persists on a longer timescale, for example, seconds to hours. FIG. 7 is an image 700 that illustrates an example effect of using persistent phosphor materials according to an implementation. The control sample shown in the left of the image 700 and the doped sample shown in the right of the image 700 were irradiated for the same amount of time. As illustrated, the luminescence from the persistent phosphor materials in the doped sample persists while the luminescence in the control sample disappears.

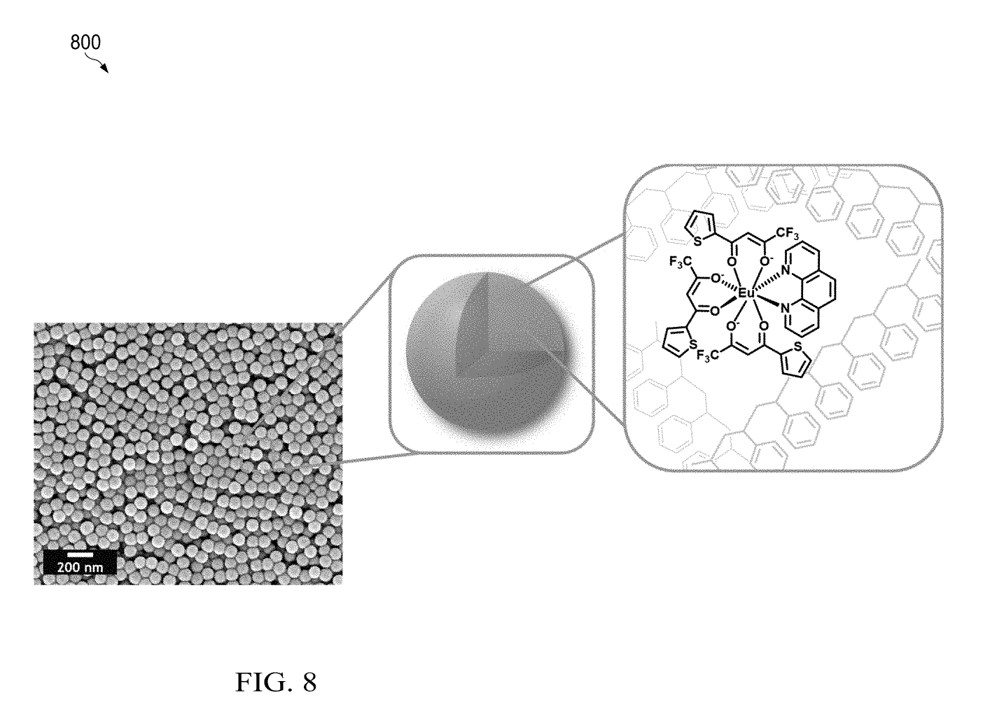

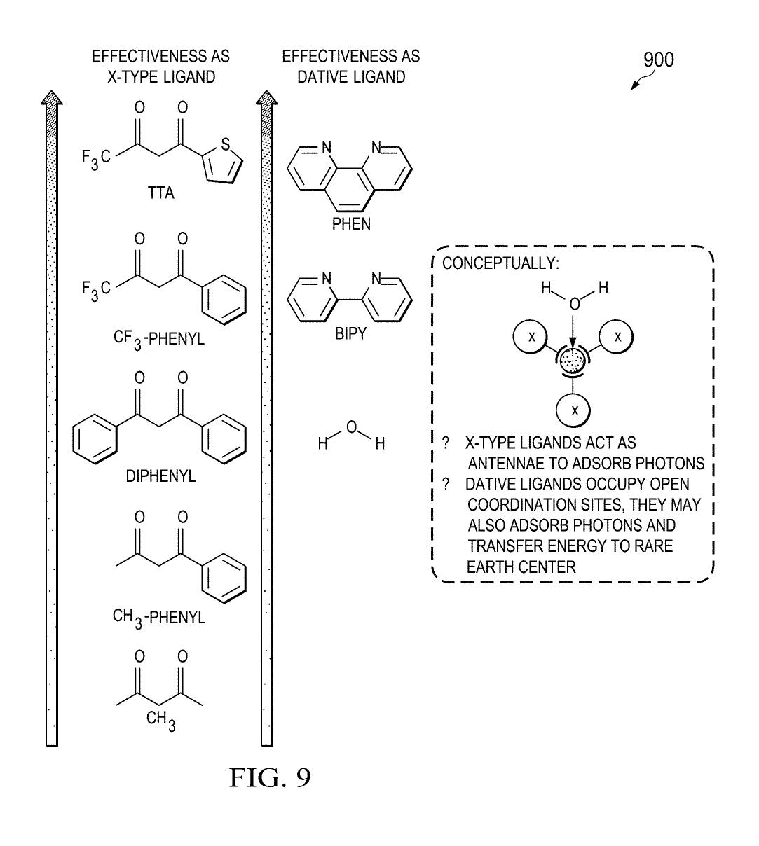

FIG. 8 is a scheme diagram 800 that illustrates the chemical structure of a sheathed lanthanide emitter according to an implementation. Such a complex contains both a rare earth ion and an organic ligand. The light-harvesting ligands serve multiple purposes, including energy transfer to the rare earth ion, whilst shielding the metal ion from the environment and tuning the physicochemical properties of the complex, for example, solubility, mass, or the like. The scheme diagram 800 illustrates the incorporation of sheathed lanthanide emitters within a polystyrene host material and a scanning electron microscopy (SEM) image of nanotracers doped with sheathed lanthanide emitters.

These complexes offer a variety of advantages over traditional fluorophores for tracing applications. The emission from these materials can be very narrow, allowing for multiple barcodes without significant spectral overlap. The timescale of sheathed lanthanide emission ranges from microseconds to milliseconds, allowing for interrogation in fluids with high background signal. Rare earth ions can be mixed and matched with various ligands to create a large library of fluorescent taggants for multimodal composite tracers. FIG. 9 is a scheme diagram 900 that illustrates example ligands according to respective implementations. The scheme diagram 900 includes illustration of X-type ligand and dative ligand. Other ligands can also be used. For example, rare earth ion selected from the lanthanide series of elements can yield a large set of ligand-ion combinations, each exhibiting unique photophysical properties. They can be detected from low parts-per-trillion (ppt) to high parts-per-quadrillion (ppq) range. Due to their compact size they can be easily incorporated into different materials such as nanoparticles and polymers, and therefore can be used to form the multi-modal tracer discussed previously.

Raman spectroscopy uses inelastic scattering due to the interaction between incident monochromatic light and molecular vibrations. This process gives rise to scattered photons with energies that do not match the energy of the light source. When molecules are placed on or near a roughened metal surface or metal nanostructure such as gold, silver, and copper, Raman signal can be significantly enhanced by an order of 10⁸-10¹⁵. Advancements in the controlled synthesis of nanostructures have further broadened the horizon of SERS phenomena to achieve single molecule sensitivities. SERS can be used as one of the detection technologies in the multi-modal detection process described previously because SERS provides ultra-low detection limits and has the resolution to uniquely identify different molecules.

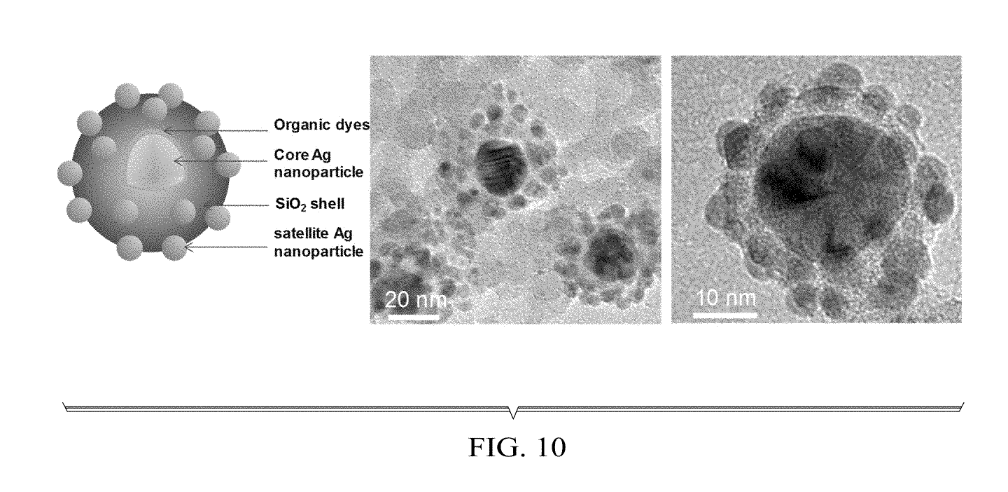

In the multi-modal detection process, SERS active mode materials can be developed as modules for multi-modal tracers. The SERS module can include nanostructured cores and satellites, specific dye molecules (or organic molecules) and shells. FIG. 10 illustrates an example SERS-active tracer according to an implementation. FIG. 10 includes the schematic drawing and the transmission electron microscopy (TEM) images of the SERS-active tracer. The SERS module is composed of metal nanostructured cores, for example gold, silver, copper, or the like, and satellite metal nanostructures, for example gold, copper, silver, or the like, which forms SERS hot spots to enhance Raman signal of specific organic molecules such as dyes. The inter-particle distances between core and satellite metal nanoparticles and morphologies for the optimum SERS properties can be controlled by adjusting thickness of silica shell during synthesis.

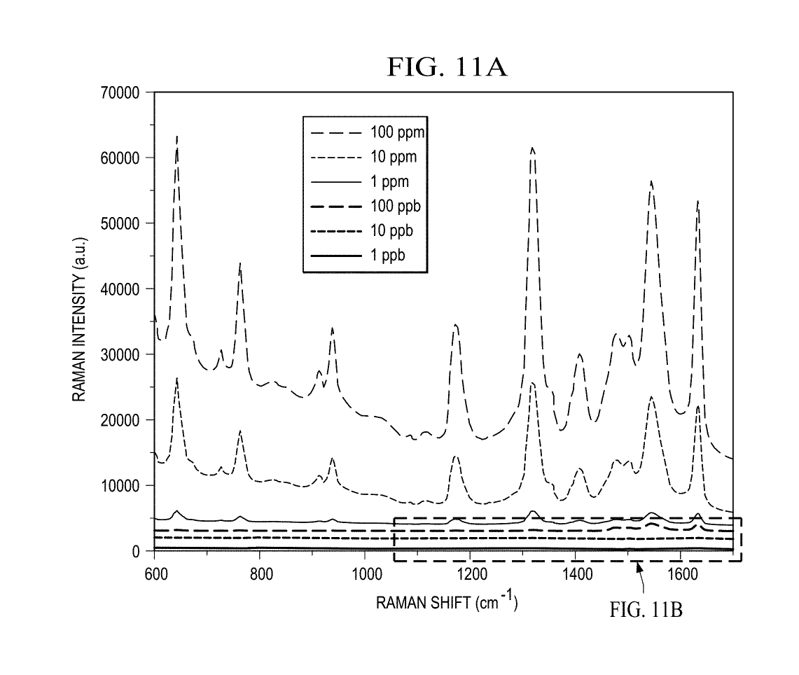

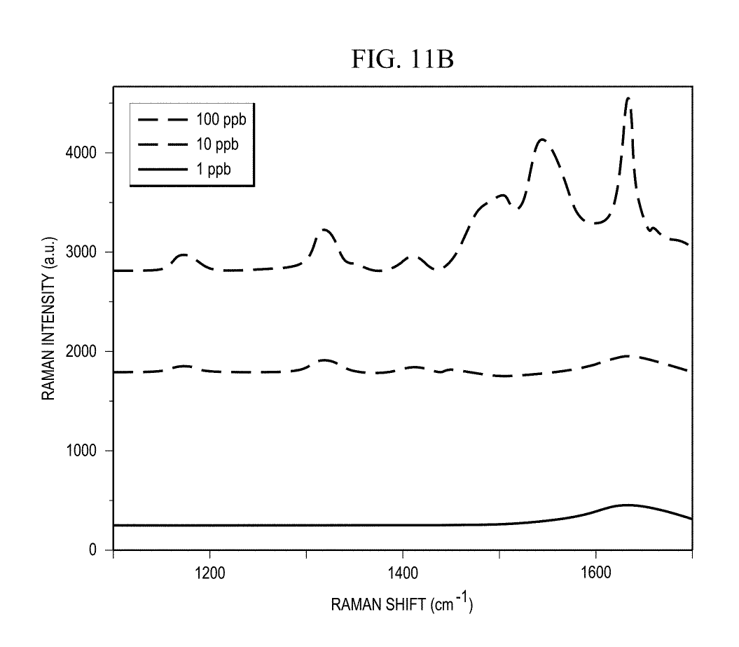

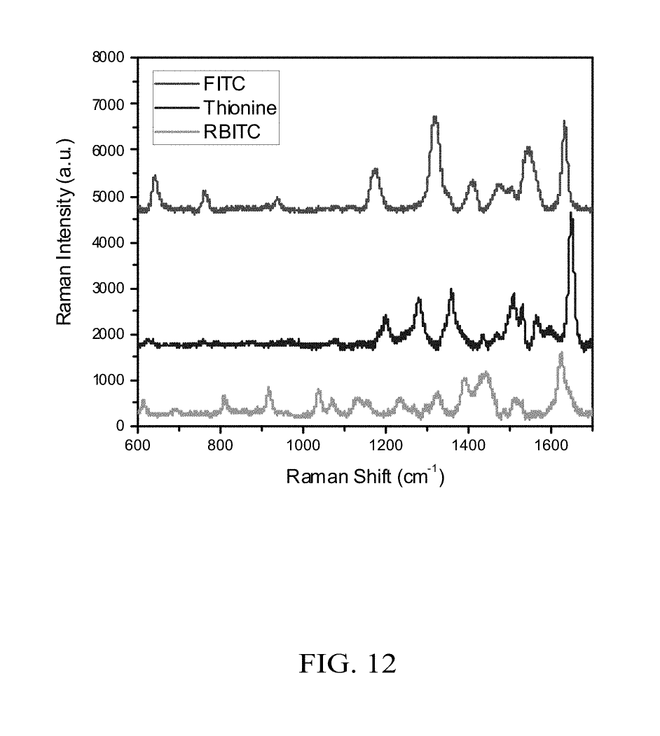

Thermally stable dye molecules embedded within nanoparticles can be detected by Raman spectroscopic techniques and yield enhanced detectability due to SERS phenomena. Many dye molecules have this characteristic, and therefore a large number of SERS taggants can be used to form the multi-modal tracer. FIGS. 11A and 11B illustrate SERS spectra associated with a nanotracer as a function of concentration according to an implementation. The intensity curves for different concentration level of the nanoparticles are plotted. As shown in FIG. 11B, even at a concentration level of 1 part per billion (ppb), monitoring the change of intensity level of one of the strong characteristic Raman shifts (around 1631 cm⁻¹), can be detected using Raman spectroscopy. FIG. 12 shows barcoding capabilities of the SERS-active tracers. The encapsulated various dye molecules such as Fluorescein isothiocyanate (FITC), Rhodamine B isothiocyanate (RBITC) and thionine for SERS-active tracers exhibit different fingerprinted Raman signals.

Mass spectrometry (MS) can be used to identify and quantify chemicals (both molecular and atomic) based on their mass to charge ratio. The analysis can be performed in two steps: (1) the analyte is ionized and (2) the mass to charge ratio is defined by the motion of the charged particles in an applied electromagnetic field. Mass spectrometry can achieve atomic mass resolution and the limits of detection can be lower than the ppt level.

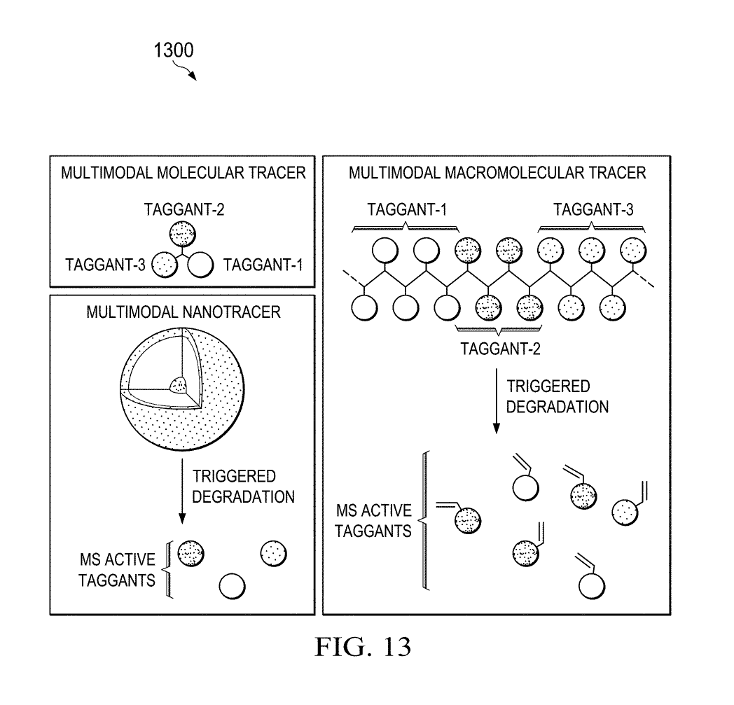

The integration of mass taggants into a multi-modal composite tracer can be achieved in a variety of ways and length scales. At the smallest length scale, a fluorescent molecule or complex exhibiting SERS activity can also be identified using mass spectrometry. Moving from the molecular to macromolecular scale, polymeric species composed of specific monomers, combinations of monomers, or side chains can be analyzed after triggered degradation. The same technique applies to nanoarchitectures, as well. FIG. 13 is a scheme diagram 1300 illustrating example multi-modal molecular tracers, example multi-modal macromolecular tracers, and example multi-modal nanotracers according to respective implementations. As shown in FIG. 13, a multiphysics detection capability can be achieved using a variety of possible architectures. For example, it could be composed of two or more molecules linked by labile covalent bonds. It can also include more complicated architectures such as copolymers and nanoparticles.

The MS taggants themselves can include organic species, inorganic ions, or a combination thereof. Mixing multiple MS taggants into a single multi-modal composite material can increase the number of possible barcodes. In the polymeric and nano-based tracer materials, triggered degradation can occur via multiple mechanisms. For example, organic polymeric materials can be depolymerized via hot filament ionization where the temperature of the filament exceeds the ceiling temperature of the polymer. Inorganic nanomaterials can be degraded through the use of inductively coupled plasma (ICP) or dissolution in an acidic medium. MS taggants can also be developed using programmed extraction capabilities. This can be implemented by doping polymeric nanomaterials with hydrophobic taggants that can be released from the nanomaterial via treatment with an appropriate solvent. Fluorinated MS taggants can provide highly targeted extraction using the concept of fluorous affinity.

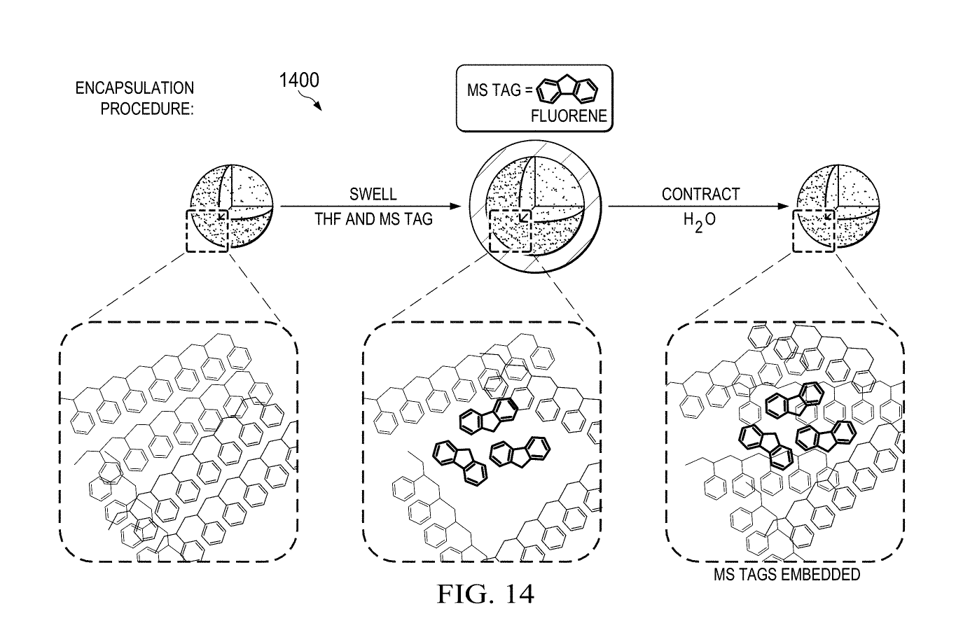

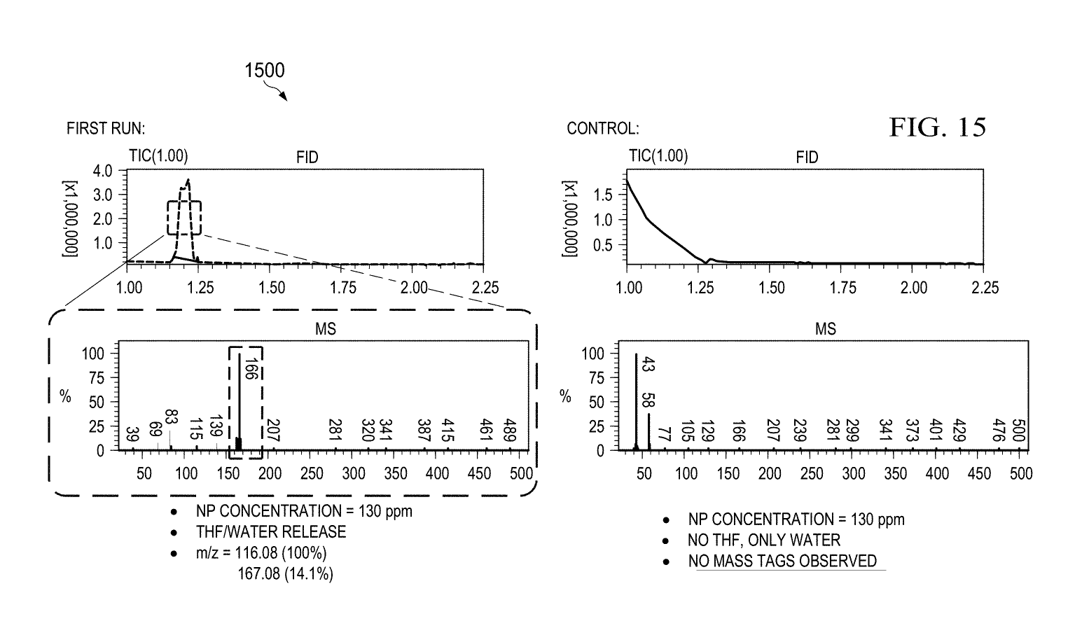

FIG. 14 is a scheme diagram 1400 illustrating an example MS taggant incorporated within polymeric nanoparticles according to an implementation. As illustrated, the polymer particles can be swollen in the presence of a suitable solvent including the taggant, and then collapsed by addition of a non-solvent to load the taggant. FIG. 15 is a scheme diagram 1500 illustrating an example MS analysis according to an implementation. As illustrated, the taggants are released by re-exposure to a good solvent, for example, Tetrahydrofuran (THF) and the effluent containing mass taggant is analyzed via Gas Chromatography Mass Spectrometry (GC-MS). As shown in these two figures, the mass taggants can be selectively removed from the particular using the good solvents. In the absence of the good solvent, the taggants may stay inside the matrix and not leach out.

This description is presented to enable any person skilled in the art to make and use the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

Accordingly, the previous description of example implementations does not define or constrain this disclosure. Other changes, substitutions, and alterations are also possible without departing from the spirit and scope of this disclosure.

What is claimed is:

1. A method, comprising:
injecting a multi-modal tracer at a first location in a reservoir, wherein the multi-modal tracer mixes with subsurface fluid in the reservoir;
collecting fluid samples at a second location in the reservoir; and
analyzing the fluid samples to detect a presence of the multi-modal tracer in the fluid samples.

2. The method of claim 1, further comprising:
determining a subsurface fluid-flow pattern based on the detected presence of the multi-modal tracer.

3. The method of claim 1, wherein the multi-modal tracer comprises a particle loaded with at least two taggants, and each of the at least two taggants is associated with a different detection technique.

4. The method of claim 1, wherein the multi-modal tracer comprises a nanoparticle.

5. The method of claim 1, wherein the multi-modal tracer is loaded with at least a fluorescence taggant and a mass spectrometry taggant.

6. The method of claim 5, wherein analyzing the fluid samples comprises:
determining a first barcode component, wherein the first barcode component represents a fluorescence signal generated using a fluorescence detection technique;
determining a second barcode component, wherein the second barcode component represents a mass spectrometry signal generated using a mass spectrometry detection technique;
generating a barcode based on the first and the second barcode components; and
comparing the generated barcode with a plurality of barcodes to detect the presence of the multi-modal tracer, each of the plurality of barcodes representing a particular multi-modal tracer.

7. The method of claim 6, wherein the fluorescence detection technique comprises an upconversion luminescence operation, and the fluorescence taggant comprises an upconverting taggant.

8. The method of claim 6, wherein the fluorescence detection technique comprises a time-gated fluorescence spectroscopy technique, and the fluorescence taggant comprises sheathed lanthanide emitters or persistent phosphor materials.

9. The method of claim 6, wherein the fluorescence detection technique is used to generate the first barcode component prior to the generation of the second barcode component using the mass spectrometry detection technique.

10. The method of claim 6, wherein the mass spectrometry taggant is incorporated in a polymeric nanoparticle.

11. The method of claim 6, wherein the mass spectrometry detection technique comprises a Gas Chromatography Mass Spectrometry operation.

12. The method of claim 6, wherein the multi-modal tracer is further loaded with a surface-enhanced Raman spectroscopy (SERS) taggant, and analyzing the fluid samples comprises:
determining a third barcode component, wherein the third barcode component represents a SERS signal generated using a SERS detection technique; and
wherein the barcode is generated based on the first, the second, and the third barcode components.

13. The method of claim 12, wherein the SERS taggant comprise a thermally stable dye molecule embedded within a nanoparticle.

14. The method of claim 1, wherein the fluid samples are analyzed in real time at the second location.

15. The method of claim 1, wherein the subsurface fluid comprises at least one of natural ga, petroleum, connate water, or seawater.

16. A multi-modal tracer for mixing with subsurface fluid in a reservoir, comprising:
a fluorescence taggant associated with a first barcode component;
a mass spectrometry taggant associated with a second barcode component; and
wherein the first barcode component and the second barcode component form a barcode that identifies the multi-modal tracer.

17. The multi-modal tracer of claim 16, wherein the fluorescence taggant comprises an upconverting taggant.

18. The multi-modal tracer of claim 16, wherein the fluorescence taggant comprises sheathed lanthanide emitters or persistent phosphor materials.

19. The multi-modal tracer of claim 16, wherein the mass spectrometry taggant is incorporated in a polymeric nanoparticle.

20. The multi-modal tracer of claim 16, further comprising:
a surface-enhanced Raman spectroscopy (SERS) taggant associated with a third barcode component; and
wherein the barcode is formed by the first, the second, and the third barcode components.
